(19) United States
(12) Patent Application Publication
(10) Pub. No.: US 2022/0228079 A1
(43) Pub. Date: Jul. 21, 2022

(54) NATURAL GAS CONDITIONING

(71) Applicant: Aspen Engineering Services, LLC, Golden, CO (US)

(72) Inventor: James M. Meyer, Golden, CO (US)

(21) Appl. No.: 16/576,394

(22) Filed: Sep. 19, 2019

Related U.S. Application Data
(63) Continuation-in-part of application No. 62/846,789, filed on May 13, 2019.

(51) Int. Cl. C10L 3/10; F25J 1/00

(52) U.S. Cl. CPC C10L 3/101; F25J 1/0022; C01B 2203/1241; F17C 2221/032; F17C 2223/0153; B01D 2257/702

(57) ABSTRACT

Rich natural gas is first compressed, and then cooled by a series of heat exchangers and an ambient air cooler. The cooled mixture of natural gas, natural gas liquid (NGL), and water is first separated in a high-pressure three-phase separator. NGL flows through a depressurization valve and NGL is separated from gas in a second separator for storage and transport such as in a conventional propane tank. A resulting lean natural gas is suitably conditioned for internal combustion, compressed natural gas processing, or liquid fuel processing.

### CROSS-REFERENCE TO RELATED APPLICATIONS

The present application is related to and claims priority to the following co-pending application, the entirety of which is incorporated by reference herein: U.S. Provisional Patent Application Ser. No. 62/846,789, titled “NATURAL GAS CONDITIONING,” filed May 13, 2019.

### FIELD OF THE INVENTION

The invention relates generally to conditioning of rich natural gas and natural gas liquid (NGL) recovery.

### BACKGROUND

Rich natural gas is produced along with crude oil when oil is produced by horizontal drilling and fracking. The produced natural gas is called associated gas and is comprised primarily of methane but also has heavier hydrocarbons including ethane, propane, butane, heptanes and hexane. The heavier hydrocarbons are often collectively called NGL. Unused gas-phase components are often wasted by the practice of flaring.

The rich natural gas causes two problems for the oil industry. First, the heavier hydrocarbons cause the gas energy content to be too high for internal combustion in engines. Specifically, the high energy content causes internal combustion engines to knock. Second, the high energy content makes the rich natural gas unsuitable for use as a compressed natural gas (CNG) fuel. The NGC process removes the valuable NGL hydrocarbons for sale and distribution while concurrently producing a lean natural gas suitable for internal combustion and CNG. Consequently, the associated gas may be put to good use instead of wasted up a flare stack.

Competing processes include mechanical refrigeration and Joule Thompson refrigeration. Mechanical refrigeration is relatively expensive and has reliability issues, particularly in cold weather. Mechanical refrigeration is also bulky and difficult to move from site to site as is often needed in oil fields. Conventional Joule Thompson refrigeration has the disadvantage of emulsifying the three-phase mixture from the depressurization valve. Consequently, NGL is often emulsified with the water.

### SUMMARY

A natural gas conditioning process (NGC) described herein conditions rich natural gas for use as a fuel while simultaneously recovering valuable natural gas liquids (NGLs). Natural gas from a well at about 50 psig is compressed by a compressor, and then cooled in multiple steps, such as through cooling with conditioned natural gas, heat exchanged with an air cooler, heat exchanged with an expanded gas from a separator, and heat exchanged by an expanded NGL stream from a separator. Some embodiments do not include all of the coolers. Subsequently, gas, NGL liquid, and water are separated in a primary separator. NGL from the primary separator is expanded and cooled. The cooled gas/liquid mixture is then separated in a second separator.

The compressor, usually provided on a separate skid, is modified to work as an integrated part of the NGC system in two ways. First, the gas from the second separator is connected by piping to allow the second separator gas to be recycled to the compressor skid to improve recovery of NGL. Second, hot gas from the compressor is piped to the condition gas cooler to provide a heat sink upstream of an ambient air cooler. The resulting pre-cooled gas is returned to the ambient air cooler (the compressor aftercooler), allowing the ambient air cooler to operate closer to the ambient air temperature.

The NGC process is differentiated by traditional mechanical refrigeration or Joule Thompson cooling systems by several features. For example, inlet gas is indirectly cooled by a Joule Thompson expansion of the separator gas and separator NGL to preclude emulsification problems that are common in traditional Joule Thompson systems. Further, the heat integration of the conditioned gas cooler upstream of the ambient air cooler is different than traditional processes. Finally, no mechanical refrigeration system is required, which simplifies the process and lowers capital cost.

Up to 80% of propane and heavier components are recoverable, depending on the rich gas composition. The intensity of the flare can be reduced by up to 50%.

### BRIEF DESCRIPTION OF THE DRAWINGS

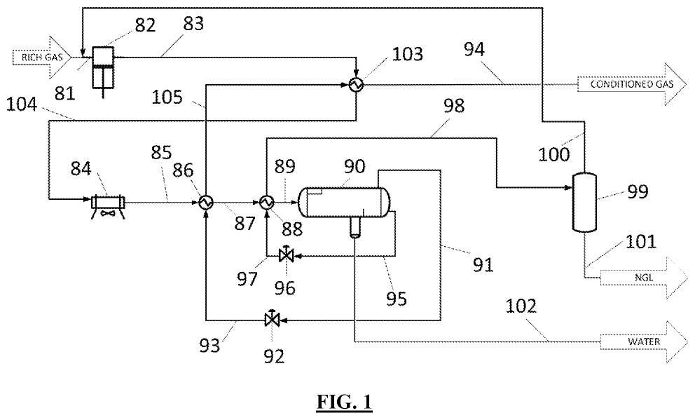

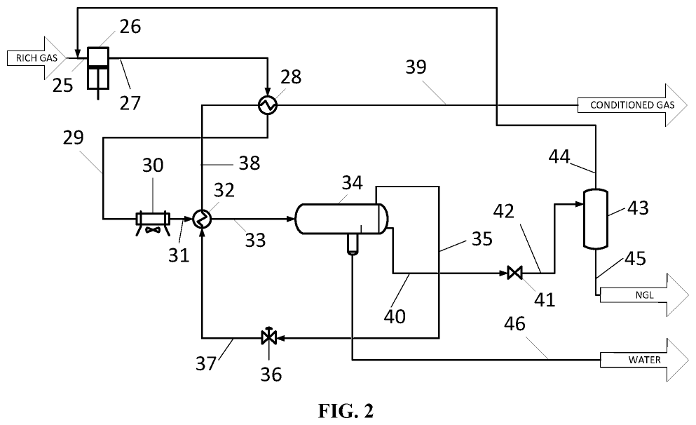

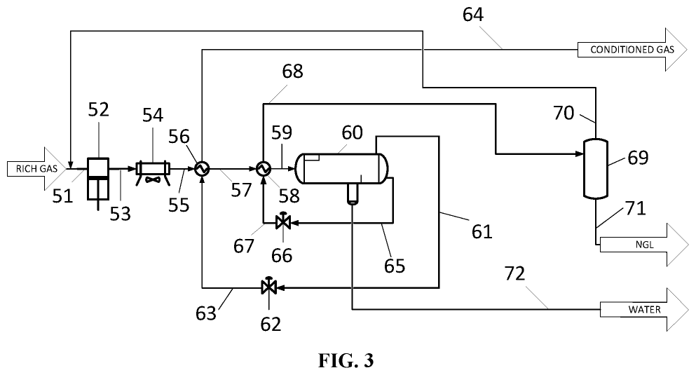

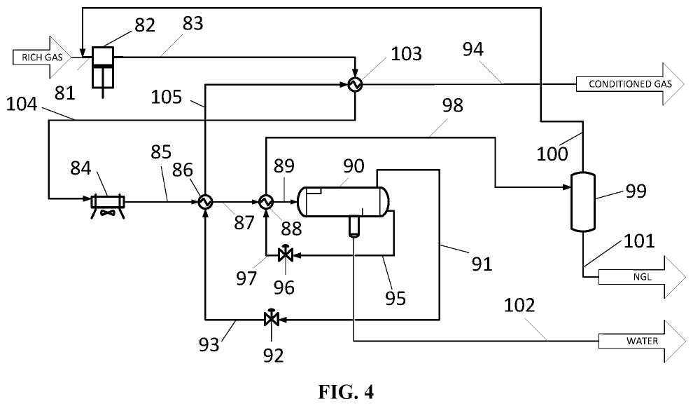

(modified) FIG. 1 is a process flow diagram for a natural gas conditioning process whereby rich natural gas is compressed and then cooled in four steps according to some embodiments.

### DETAILED DESCRIPTION

### An Embodiment of a Natural Gas Conditioning Process

(modified) Referring now to FIG. 1, in another embodiment of the system with multiple cooling steps. A first cooling step is by heat exchange with conditioned gas. Cooling step two is accomplished in an air cooler. Cooling step three is by a gas expansion cooler. Finally, cooling step four occurs in a NGL expansion cooler. NGL is separated from water and natural gas by first a high pressure three-phase separator, and then a low pressure two-phase separator. A rich natural gas 81 serves as a feed into the system and flows into a compressor 82. The compressor 82 compresses the rich natural gas 81 to a pressure between about 600 psig and 1200 psig, and a temperature of the rich natural gas rises to about a temperature in the range of 200 to 300 deg. F. The hot, compressed gas is cooled in a conditioned gas cooler 103. The cooled gas 104 from conditioned gas cooler 103 is further cooled in an air cooler 84, such as by ambient air, to about a temperature between 50 deg. F. and 100 deg. F. A result is a cooled gas/NGL mixture 85. The cooled gas/NGL mixture 85 from the air cooler 84 is further cooled by flowing the mixture 85 into the hot side of a gas expansion cooler 86. The gas expansion cooler 86 turns the mixture 85 into a cooled gas/NGL/water mixture 87, which then flows into a hot side of a NGL expansion cooler 88 and into a first separator 90 as an inbound gas/NGL/water mixture 89.

Three streams exit the first separator 90. Water 102 flows from a bottom of the first separator 90. The water 90 can be then be put to other uses downstream directly or after treatment to remove any residual components from the separation.

Conditioned gas 91 exits the first separator 90 and flows through a gas expansion valve 92. The gas expansion valve 92 facilitates keeping pressure inside the first separator 90 at a working pressure approximately between 600 psig and 1200 psig depending on a composition and characteristics of the inbound gas/NGL/water mixture 89. Gas 93 from the gas expansion valve 92 flows through the cold side of the gas expansion cooler 86. The conditioned gas 64 from expansion cooler 86 exits at a pressure approximately between 50 psig and 400 psig and at a temperature between 50 and 200 deg. F. Conditioned gas 105 flows into a cold side of the conditioned gas cooler 103 and leaves the system as conditioned gas 94.

NGL 95 exits the first separator 90 and flows through a NGL valve 96. A cooled NGL/gas mixture 97 from the NGL valve 96 flows into the cold side of NGL expansion cooler 88. NGL/gas mixture 98 from the NGL expansion cooler 88 flows into a second separator 99 where gas 100 is separated from an output stream of NGL 101. The NGL 101 exits at a pressure approximately between 100 psig and 250 psig and at a temperature between 20 and 80 deg. F. The recycle gas 100 exits at a pressure approximately between 100 psig and 250 psig and at a temperature between 20 and 80 deg. F. The gas 100 may be recycled to the compressor 81 or put to another use downstream directly or after treatment. Relative ratios of the three streams 91, 95 and 102 vary according to a composition of the rich natural gas 81.

Embodiments and variations thereof, illustrated in the accompanying figure(s) are not to scale. The technical subject matter described above is merely illustrative, and, along with the figures, is not meant to limit the scope of the invention. It is to be appreciated that numerous other variations of the invention have been contemplated, as would be obvious to one ordinary skilled in the art given the benefit of the disclosure. All variations of the invention that read upon appended claims are intended and contemplated to be within the scope of the invention.

1. A natural gas conditioning system comprising:
a first separator connected with an ambient air cooler and a gas expansion cooler, the first separator adapted to receive a compression fluid, the compression fluid including a gas, natural gas liquid (NGL), and water, and wherein the first separator is configured to separate the gas, the NGL, and the water into separate flows;
wherein the ambient air cooler is disposed upstream of the first gas expansion cooler, and wherein the ambient air cooler is configured to:
cool the compression fluid, and
deliver cooled compression fluid to a hot side of the gas expansion cooler; and
wherein:
the gas expansion cooler is disposed upstream of the first separator,
the gas expansion cooler is disposed downstream of the ambient air cooler, and
the gas expansion cooler is configured to deliver cooled compression fluid to the first separator;
a gas valve disposed downstream of the first separator configured to receive conditioned gas from the first separator;
wherein the gas expansion cooler is configured to receive conditioned gas from the gas valve on a cold side of the gas expansion cooler;
a NGL valve disposed downstream of the first separator configured to receive NGL from the first separator; and
a second separator disposed downstream of the NGL valve and configured to separate a gas from a hydrocarbon-based liquid at a bottom of the second separator.

2. The system of claim 1 further comprising a compressor upstream from ambient air cooler and configured to receive the compression fluid, and wherein a portion of the separated gas from the second separator is recycled to the compressor.

3. The system of claim 1, wherein the ambient air cooler cools the compression fluid to approximately a temperature between 50 deg. F. and 100 deg. F.

4. The system of claim 1, wherein conditioned gas exits the system at a pressure approximately between 50 psig and 400 psig or at a temperature between 50 and 200 deg. F.

5. A natural gas conditioning system comprising:
a first separator connected with a conditioned gas cooler, an ambient air cooler, and a gas expansion cooler, wherein the first separator is positioned to receive a compression fluid, the compression fluid including a gas, natural gas liquid (NGL), and water, and wherein the first separator is configured to separate the gas, the NGL, and the water into respective separate flows;
wherein:
the conditioned gas cooler is disposed upstream of the ambient air cooler,
the conditioned gas cooler is configured to cool the compression fluid,
the conditioned gas cooler is configured to deliver cooled compression fluid to the ambient air cooler; and
wherein:
the ambient air cooler is disposed upstream of the gas expansion cooler,
the ambient air cooler is configured to cool the compression fluid, and
the ambient air cooler is configured to deliver cooled compression fluid to the hot side of the gas expansion cooler; and
wherein:
the gas expansion cooler is disposed upstream of the first separator,
the gas expansion cooler is disposed downstream of the ambient air cooler, and
the gas expansion cooler is configured to deliver cooled compression fluid to the first separator;
a gas valve disposed downstream of the first separator and configured to receive conditioned gas from the first separator;
wherein the gas expansion cooler is configured to receive conditioned gas from the gas valve on a cold side of the gas expansion cooler;
a NGL valve disposed downstream of the first separator configured to receive NGL from the first separator; and
a second separator disposed downstream of the NGL valve and configured to separate a gas from a hydrocarbon-based liquid at a bottom of the second separator.

6. The natural gas conditioning system of claim 5, further comprising a compressor, wherein the compressor is configured to compress the compression fluid, and wherein a portion of the separated gas from the second separator is recycled to the
compressor.

7. A natural gas conditioning system comprising:
a first separator connected with an ambient air cooler;
a gas expansion cooler; and
an NGL cooler and adapted to receive a compression fluid, wherein the compression fluid including a gas, natural gas liquid (NGL), and water, and wherein the first separator is configured to separate the gas, the NGL, and the water into separate flows;
wherein:
the ambient air cooler is disposed upstream of the gas expansion cooler,
the ambient air cooler is configured to cool the compression fluid, and
the ambient air cooler is configured to deliver cooled compression fluid to the hot side of the gas expansion cooler; and
wherein:
the gas expansion cooler is disposed upstream of the first separator,
the gas expansion cooler is disposed downstream of the ambient air cooler, and
the gas expansion cooler is configured to deliver cooled compression fluid the hot side of the NGL expansion cooler; and
wherein:
the NGL expansion cooler is disposed upstream of the first separator,
the NGL expansion cooler is disposed downstream of the gas expansion cooler, and
the NGL expansion cooler is configured to deliver cooled compression fluid to the first separator;
a gas valve disposed downstream of the first separator and configured to receive conditioned gas from the first separator;
wherein:
the gas expansion cooler is configured to receive conditioned gas from the gas valve on a cold side of the gas expansion cooler;
a NGL valve disposed downstream of the first separator and configured to receive NGL from the first separator; and
wherein:
the cold side of the NGL cooler is disposed downstream of the NGL valve, and
the cold side of the NGL cooler is configured to receive cold NGL fluid; and
a second separator disposed downstream of the cold side of the NGL cooler and configured to separate a gas from a hydrocarbon-based liquid at a bottom of the second separator.

8. The system of claim 7, further comprising a compressor configured to compress the compression fluid, and wherein a portion of the separated gas from the second separator is recycled to the compressor.

9. A natural gas conditioning system comprising:
a first separator connected with a conditioned gas cooler;
an ambient air cooler;
a gas expansion cooler; and
an NGL cooler adapted to receive a compression fluid, the compression fluid including a gas, natural gas liquid (NGL), and water, and wherein the first separator is configured to separate the gas, the NGL, and the water into separate flows;
wherein:
the conditioned gas cooler is disposed upstream of the ambient air cooler,
the conditioned gas cooler is configured to cool the compression fluid, and
the conditioned gas cooler is configured to deliver cooled compression fluid to the ambient air cooler; and
wherein:
the ambient air cooler is disposed upstream of the gas expansion cooler,
the ambient air cooler is configured to cool the compression fluid, and
the ambient air cooler is configured to deliver cooled compression fluid to the hot side of the gas expansion cooler; and
wherein:
the gas expansion cooler is disposed upstream of the first separator,
the gas expansion cooler is disposed downstream of the ambient air cooler, and
the gas expansion cooler is configured to deliver cooled compression fluid the hot side of the NGL expansion cooler; and
wherein:
the NGL expansion cooler is disposed upstream of the first separator,
the NGL expansion cooler is disposed downstream of the gas expansion cooler, and
the NGL expansion cooler is configured to deliver cooled compression fluid to the first separator;
a gas valve disposed downstream of the first separator and configured to receive conditioned gas from the first separator;
wherein the gas expansion cooler is configured to receive conditioned gas from the gas valve on a cold side of the gas expansion cooler;
a NGL valve disposed downstream of the first separator and configured to receive NGL from the first separator;
wherein:
the cold side of the NGL cooler is disposed downstream of the NGL valve, and
the cold side of the NGL cooler is configured to receive cold NGL fluid; and
a second separator disposed downstream of the cold side of the NGL cooler and configured to separate a gas from a hydrocarbon-based liquid at a bottom of the second separator.

10. The system of claim 9, further comprising a compressor configured to compress the compression fluid, and wherein a portion of the separated gas from the second separator is recycled to the compressor.

11. The system of claim 9, wherein conditioned gas exits the system at a pressure approximately between 50 psig and 400 psig.

12. The system of claim 9, wherein conditioned gas exits the system at a temperature between approximately 50 and 200 deg. F.
